(19) United States
(12) Patent Application Publication
(10) Pub. No.: US 2026/0284596 A1
(43) Pub. Date: Sep. 24, 2026

(54) SYSTEM AND METHOD FOR IMPROVED FLOW DISTRIBUTION IN A HYPERFILTRATION ARRAY

(71) Applicant: DDP SPECIALTY ELECTRONIC MATERIALS US, LLC, Wilmington, DE (US)

(72) Inventors: Steven JONS, Edina, MN (US); Robert HUEHMER, Edina, MN (US)

(21) Appl. No.: 19/477,028

(22) PCT Filed: Apr. 17, 2024
(86) PCT No.: PCT/US2024/024914

§ 371 Date: Oct. 20, 2025

Related U.S. Application Data
(60) Provisional application No. 63/497,700, filed on Apr. 21, 2023.

(51) Int. Cl. B01D 61/02; B01D 61/10; B01D 61/12

(52) U.S. Cl. CPC B01D 61/025; B01D 61/10; B01D 61/12; B01D 2311/25; B01D 2313/48

(57) ABSTRACT

The present invention provides a batch or semi-batch method and system for treating a feed solution. A hyperfiltration system is suitable to switch between two modes: a recirculation step wherein the retentate stream from hyperfiltration membrane elements is recycled and a flush step that displaces a retentate stream to an outlet. The hyperfiltration system includes an array design optimized to increase the flush efficiency during the flush step by equalizing the hydraulic residence time of different flow paths through a pressure vessel array. The substantially equal hydraulic residence times result in more uniform displacement of solute from the system, lower over-all flush volumes to displace accumulated solutes, and minimal variation in the age distribution of solute that accumulates within the system.

### CROSS-REFERENCE TO RELATED APPLICATION

The present application claims priority under 35 U.S.C. § 365 (c) to U.S. Provisional Appln. No. 63/497,700, filed on Apr. 21, 2023, which is incorporated herein by reference in its entirety.

### FIELD OF THE INVENTION

The present invention relates to a system and method for batch and semi-batch filtration of a feed solution using hyperfiltration. More specifically, provided herein is a hyperfiltration system that includes an array of filtration vessels within a recirculation loop that is configured to result in a more efficient flushing cycle.

### BACKGROUND OF THE INVENTION

Several patents, patent applications and publications are cited in this description in order to more fully describe the state of the art to which this invention pertains. The entire disclosure of each of these patents, patent applications, and publications is incorporated by reference herein.

The combination of climate change and water scarcity has resulted in an increased need to purify alternative water supplies for beneficial use at lower energy consumption. Currently, conventional hyperfiltration is largely used to fulfill this need. Conventional hyperfiltration is a pseudo steady state hyperfiltration membrane process wherein a pressurized feed stream is continuously divided into two streams, a permeate stream that has low solute concentrations and a retentate stream that has high solute concentration. The recovery of the system is generally defined as the ratio of the permeate flow and the feed flow. Additional recovery of the feed stream is accomplished by adding additional hyperfiltration membrane elements in series. Consequently, a conventional hyperfiltration system operates over a very narrow range of recoveries for any specific design. The physical engineering design of a conventional hyperfiltration system can also impact the over-all recovery, water quality, and flux of the system. Additional studies have found that the recovery of individual membrane element pressure vessels, and consequently hyperfiltration membrane elements, can be negatively impacted by the physical design of the hyperfiltration system (Verhuelsdonk et al., “Modeling the impact of using multi-port RO pressure vessels in seawater reverse osmosis desalination plants using special simulation software,” Desalination and Water Treatment 5 (2009) 192-197 (www.deswater.com)). Verhuelsdonk examined a hypothetical conventional hyperfiltration system used to treat seawater and determined that maldistribution of flow in a membrane pressure vessel array can negatively impact the recovery of elements in different pressure vessels. This can result in differential fouling and scaling in a conventional hyperfiltration system, compounding issues associated with conventional hyperfiltration systems.

Hyperfiltration systems have been developed to specifically address the spatial limitations on recovery within a fixed, steady-state conventional hyperfiltration system. Batch and semi-batch hyperfiltration are recently developed methods of desalinating an aqueous solution using hyperfiltration that utilizes two distinct main modes of operation. During the first mode, the solute rich retentate stream is recycled and mixed with the feed stream prior to entering a pressure vessel containing membranes. Consequently, the concentration of solutes in the retentate increases over the duration of the first mode operation. In the second mode, the retentate is directed to waste, allowing for de-concentration of the accumulated solutes from within the system. The pressure of the solution fed to the hyperfiltration membrane elements is adjusted to provide the desired production of permeate containing low solute concentrations. There are a number of benefits to these batch and semi-batch hyperfiltration systems, including lower energy consumption and the ability to operate over a wide range of different recoveries by decoupling the system design from a target recovery.

Operational experience with the systems described by Efraty (for example, in U.S. Pat. Nos. 7,695,614; 7,628,921; and 8,025,804) has demonstrated that some of the benefits of semi-batch hyperfiltration can be reduced significantly when there is solute retention in the system at the end of a cycle of the second mode of operation. For example, accumulated solutes can increase the required feed pressure to support permeation resulting in increased energy savings. The accumulated solutes will typically also degrade the treated solution stream. If the solutes are comprised of sparingly soluble salts, there is an increased risk of scaling due to ‘aging’ of the salt retained in the system. For scaling applications, extended second mode of operation is often beneficial to reduce solute retention. Clearly, however, there remains a need for a batch hyperfiltration system that minimizes salt retention in the system, allowing for improved operation of the semi-batch system.

### SUMMARY OF THE INVENTION

Accordingly, provided herein is a semi-batch/batch hyperfiltration system for treating or purifying a solution containing solutes.

In a first aspect of the invention, the system comprises:
a source of fluid to be treated;
a recirculation loop for treating said fluid, said recirculation loop comprising:
   a pressure vessel array having an array inlet for feed, an array outlet for retentate, and a permeate discharge line, and
   a recirculation means suitable to increase fluid pressure between the array outlet and the array inlet;
a valve collection suitable to restrict flow within said recirculation loop, suitable to enable a discontinuous release of concentrated fluid from the recirculation loop to a waste outlet, and optionally also suitable to restrict flow from the recirculation loop to a waste outlet, wherein at least one component of said valve collection is within said recirculation loop;
a high-pressure pump suitable to introduce a pressurized fluid from the fluid source into the recirculation loop;
a control device suitable to actuate said valve collection; and
wherein said pressure vessel array comprises a pressure vessel stack assembly, said pressure vessel stack assembly comprising:
   a plurality of parallel pressure vessels comprising a first pressure vessel, a last pressure vessel and at least one pressure vessel located between said first and last pressure vessel;
   wherein each of said pressure vessels comprises one or more inlet ports located nearest a first end of said pressure vessel, one or more outlet ports located nearest a second end of said pressure vessel, and a permeate port located at one of said ends of said pressure vessel; and wherein the inlet ports of adjacent pressure vessels are connected at said first end and the outlet ports of adjacent pressure vessels are connected at said second end;
   an inlet conduit fluidly connecting a stack inlet to the inlet ports of said plurality of parallel pressure vessels; wherein said stack inlet is located nearest the inlet port of the first pressure vessel;
   an outlet conduit fluidly connecting a stack outlet and the outlet ports of said plurality of parallel pressure vessels; wherein said stack outlet is located nearest the outlet port of the last pressure vessel;
   and wherein each of the individual pressure vessels provides a unique flow path within the recirculation loop that passes sequentially through the array inlet, the stack inlet, the individual pressure vessel, the stack outlet, and the array outlet.
      Further provided is a method of operating a batch or semi-batch hyperfiltration using the above-described system, wherein the system alternates between a first mode of operation and a second mode of operation, and wherein feed solution is used to displace solutes from the system.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. 1 illustrates a single multi-ported pressure vessel of the prior art in cross-section, showing the hyperfiltration membrane elements contained therein.

FIG. 2 illustrates a preferred embodiment of the pressure vessel stack assembly described herein in cross-section, showing a plurality of parallel pressure vessels connected to each other using side-ports, and also showing the preferred placement of the inlet and outlet headers.

FIG. 3 illustrates an alternative embodiment of the pressure vessel stack assembly described herein, showing a plurality of end-ported vessels, each connected to an inlet distribution pipe and an outlet distribution pipe. The distributions pipes are connected to the respective inlet and outlet headers and show the preferred placement.

FIG. 4a illustrates an isometric view of a preferred embodiment of the pressure vessel array described herein.

FIG. 4b illustrates an isometric view of a preferred embodiment of the pressure vessel array described herein, wherein the recirculation loop includes a pressure vessel array with a split header.

FIG. 5a illustrates a schematic for the batch-wise hyperfiltration system operating in a first mode.

FIG. 5b illustrates a schematic for the batch-wise hyperfiltration system operating in a second mode.

FIG. 6a illustrates a cross-section of a pressure vessel stack assembly of the prior art, in which the individual flow paths are depicted as dotted lines.

FIG. 6b illustrates a cross-section of a preferred pressure vessel stack assembly described herein, in which the individual flow paths are depicted as dotted lines.

FIG. 7a is a graph showing solute concentration vs. time in the waste stream during a second mode of operation of a treatment system comprising a hyperfiltration array of the prior art.

FIG. 7b is a graph focusing on the transition region of FIG. 7a and illustrating the solute concentration vs. time for a combined stream resulting from paths through different individual pressure vessels.

FIG. 8a is a graph showing solute concentration vs. time in the waste stream during a second mode of operation of a treatment system comprising a preferred embodiment of the hyperfiltration array described herein.

FIG. 8b is a graph focusing on the transition region of FIG. 8a and illustrating the solute concentration vs. time for a combined stream resulting from paths through different individual pressure vessels.

### DETAILED DESCRIPTION OF THE INVENTION

Provided herein are a batch or semi-batch hyperfiltration system and methods of operating the system. The system described herein provides improved flushing of the system, resulting in improved removal of solutes from the system, a reduction in solute accumulation in the system, reduced operating pressures and energy consumption, and lower scaling risk when concentrating sparingly soluble salts, as compared to other configurations of batch or semi-batch hyperfiltration, such as the systems described in U.S. Pat. Nos. 7,695,614; 7,628,921; and 8,025,804, for example.

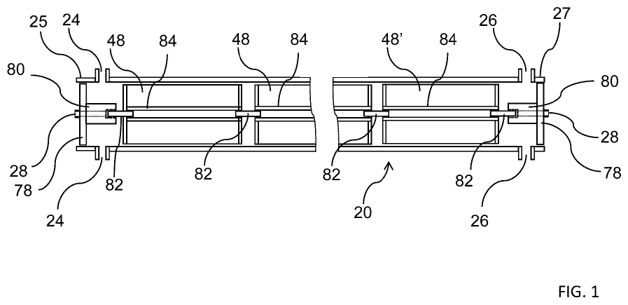

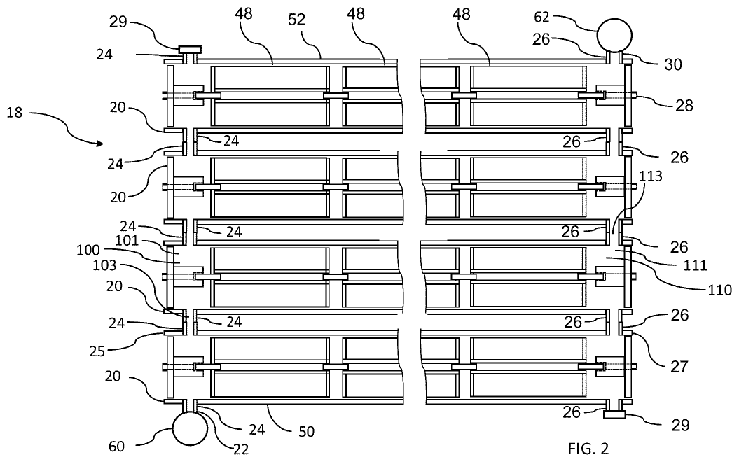

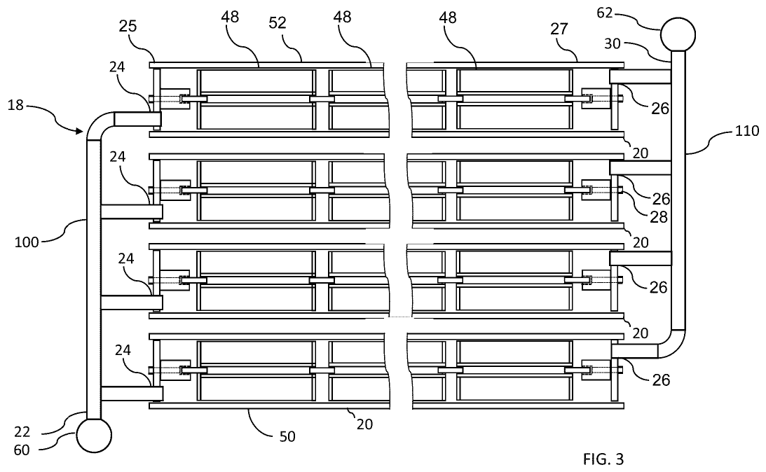

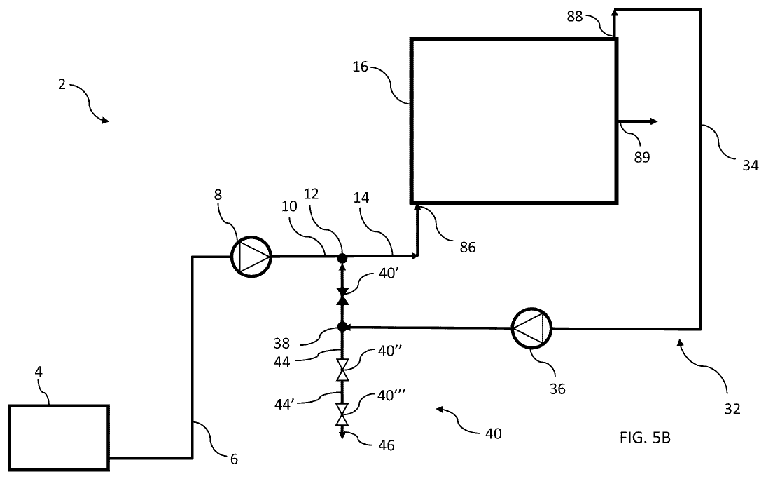

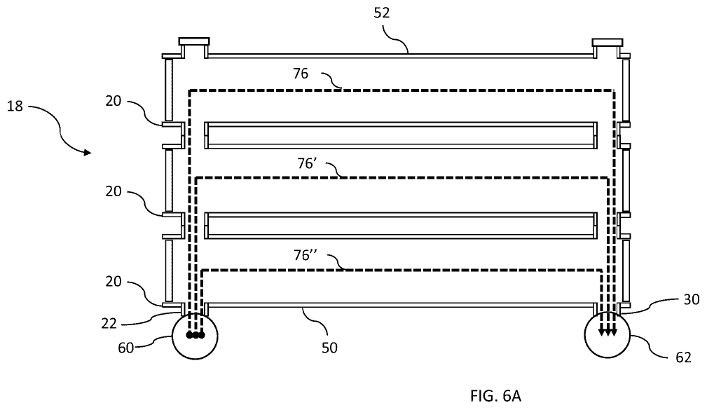

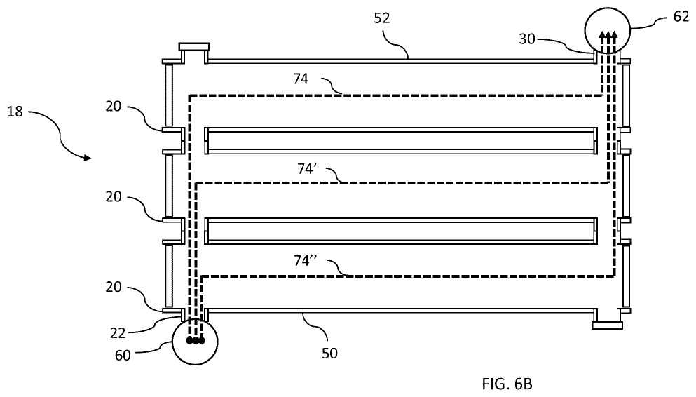

Referring now to the drawings, wherein like reference numerals designate corresponding structure throughout the views, and referring in particular to FIG. 1, a pressure vessel 20 of the prior art is shown. A pressure vessel 20 is a multi-port vessel that comprises at least one inlet port 24 located nearest a first end 25 of the pressure vessel 20 and at least one outlet port 26 located nearest a second end 27 of the pressure vessel. In the embodiment of FIG. 1, two inlet ports 24 and two outlet ports 26 are all shown located on the sides of the vessel (side-ported). This arrangement facilitates connecting the vessels in parallel (FIG. 2). In some cases, such as at the first or last vessel of an array of connecting vessels, as discussed in detail below with respect to FIGS. 6a and 6b, two ports are not needed on each end of the vessel. In other vessel configurations (see, e.g., FIG. 3), inlet ports 24 and outlet ports 26 are located at a first end 25 and second end 27, respectively, of the pressure vessel 20. A permeate port 28 is located on at least one end of the pressure vessel 20. FIG. 1 illustrates a pressure vessel 20 with permeate ports 28 on both the first end 25 and the second end 27. Undesired side ports can either be omitted from the pressure vessel 20, or they can be fitted with a cap 29 as shown in FIG. 2.

The pressure vessel 20 contains one or more hyperfiltration membrane elements 48 (for example as described in U.S. Pat. No. 5,538,642) installed in series, oriented axially with the pressure vessel 20. The hyperfiltration membrane elements 48 contain membranes that preferentially pass solvent from the feed-concentrate side of the membrane to a permeate side, typically rejecting most solutes in the feed-concentrate, resulting in the formation of a retentate solution on the feed-concentrate side of the membrane. The solvent that passes through the membrane, commonly referred to as permeate, is collected in a membrane element permeate tube 84. The permeate tubes 84 are shown connected with permeate interconnectors 82, each of which has a sealing mechanism (not shown). Permeate typically flows through the permeate tubes 84 and permeate interconnectors 82, to be extracted from the pressure vessel 20 through the permeate port 28. The axis along which the membranes are oriented preferably coincides with the permeate tubes 84. For clarity, sealing means between the various interconnecting parts (e.g. permeate tubes 84, permeate interconnectors 82, permeate adapters 80) are omitted from the drawings and descriptions. Sealing means between these parts typically include O-rings. Chevron sealing rings, u-cup rings, and other similar form factors are also suitable. In some cases, sealing means may be partially set into a retaining groove. Sealing means are preferably partially compressed between the two parts that they connect, blocking flow through the connection between components. Sealing means are typically comprised of an elastomeric material, although harder plastics have been used (for example as described in WO2011/041004). In some instances, an alternative sealing mechanism is used between adjacent membrane elements, as for example, the interlocking endcaps described in U.S. Pat. No. 6,632,356.

Referring now to FIGS. 2 and 3, multiple pressure vessels 20 may be assembled into a pressure vessel stack assembly 18 in either a vertical or horizontal alignment. A pressure vessel stack assembly 18 comprises a plurality of parallel pressure vessels 20. In preferred embodiments, a pressure vessel stack assembly 18 comprises at least three parallel pressure vessels 20, such that there is a first pressure vessel 50, a last pressure vessel 52 and at least one pressure vessel 20 located between said first pressure vessel 50 and said last pressure vessel 52. Pressure vessels may be considered “parallel” based on their corresponding connections, akin to the way resistors in an electrical circuit are understood to be parallel. Inlet ports 24 of different parallel pressure vessels 20 are connected by an inlet conduit 100 common to all pressure vessels 20 within a single stack assembly 18. Similarly, outlet ports 26 of different parallel pressure vessels 20 are connected by an outlet conduit 110 common to all pressure vessels 20 in a single stack assembly 18. While “parallel” vessels are not defined by their relative orientation in space, pressure vessels 20 are also preferably arranged in space to be essentially geometrically parallel. The term “essentially geometrically parallel” as used herein in connection with pressure vessels refers to pressure vessels that are aligned such that the angle between their cylindrical axes or the angle between their central axes is less than 10°.

FIG. 2 shows connecting adjacent pressure vessels 20 using inlet ports 24 that are adjacent to each other and outlet ports 26 that are adjacent to each other. These connections are preferably made using Victaulic style connections, although flanged connections, threaded connections, and welded connections are all possible means of connecting the vessels in parallel. Additional pressure vessels 20 can be installed in parallel using a similar configuration. The two parallel pressure vessels 20 within the pressure vessel stack assembly 18 that are furthest from each other are designated the first pressure vessel 50 and the last pressure vessel 52. Inlet ports 24 of adjacent pressure vessels 20 are connected near their first ends 25 by an inlet conduit 100 and outlet ports 26 of adjacent pressure vessels 20 are connected at their second ends 27 by an outlet conduit 110. The inlet conduit 100 fluidly connects a stack inlet 22 to the inlet ports 24 of parallel pressure vessels 20, wherein the stack inlet 22 is located nearest an inlet port 24 of the first pressure vessel 50 such that the total flow into the stack passes through the stack inlet 22. Similarly, the outlet conduit 110 fluidly connects a stack outlet 30 and the outlet ports 26 of pressure vessels 20 installed in parallel. The stack outlet 30 is located nearest the outlet port 26 of the last pressure vessel 52, such that the total retentate flow leaving the stack passes through the stack outlet 30.

In this configuration, the number of pressure vessels 20 in each pressure vessel stack assembly 18 is preferably greater than 2 and less than 8. The higher value is based upon the development of pressure drop through the inlet ports 24 and outlet ports 26 during flow. Ideally, the pressure drop in the hyperfiltration elements will be greater than that of the ports, to provide a more equal flow in each pressure vessel 20. More preferably, the ratio of the pressure drop down a pressure vessel (from inlet port 24 to outlet port 26) to the maximum pressure difference on the same end between two parallel pressure vessels (either on the first end 25 or the second end 27) exceeds 5 to 1, more preferably 10 to 1, and even more preferably 15 to 1.

Stated alternatively, the pressure vessel array 16 has a first pressure drop between the inlet port 24 and the outlet port 26 of one pressure vessel 20; the pressure vessel array 16 also has a second pressure drop that is the maximum difference in the pressure between either both first ends 25 or both second ends 27 of two parallel pressure vessels 20; and the ratio of the first pressure drop to the second pressure drop is greater than 5:1, more preferably greater than 10:1, more preferably greater than 15:1.

Inlet conduits 100 and outlet conduits 110 can take different forms in different systems. However, each inlet conduit 100 contains a flow path for distributing a common solution for treatment (also referred to herein as “feed”) into multiple parallel vessels through the inlet ports 24. Similar, each outlet conduit 110 contains a flow path for collecting and combining the retentate streams from outlet ports 26 of multiple parallel vessels 20. In the embodiment illustrated in FIG. 2, the vessels 20 are side-ported and the inlet conduit 100 contains both void regions 101 located within individual adjacent vessels 20 (upstream of all elements within the vessel) and the open regions 103 for flow within inlet ports 24 that connect these adjacent vessels 20. Similarly, the outlet conduit 110 in FIG. 2 contains both void regions 111 located within individual adjacent vessels 20 (downstream of all elements within the vessel) and the open regions 113 for flow within the outlet ports 26 that connect these adjacent vessels 20.

FIG. 3 illustrates an alternative embodiment using end-ported hyperfiltration vessels 20 that also results in a pressure vessel stack assembly 18. In this embodiment, the inlet conduit 100 is a manifold suitable to distribute a common feed solution into the inlet ports 24 of multiple parallel pressure vessels 20. Similarly, the outlet conduit 110 is a manifold that connects the outlet ports 26 from the different parallel pressure vessels 20 to a common retentate stream. As in the embodiment of FIG. 2, the inlet header 60 is connected to a stack inlet 22 which is connected to the inlet conduit 100. Similarly, the outlet header 62 is connected to a stack outlet 30 which is connected to the outlet conduit 110.

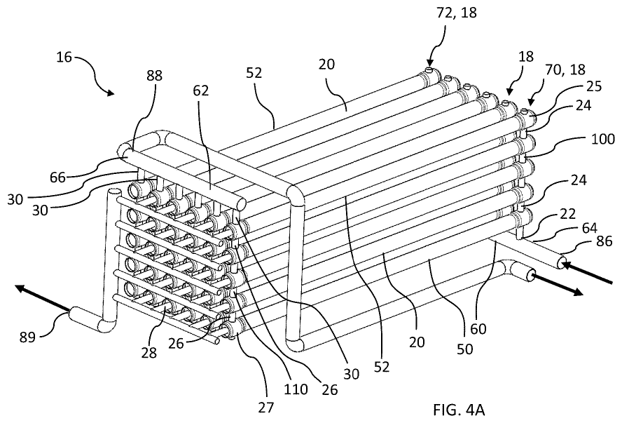

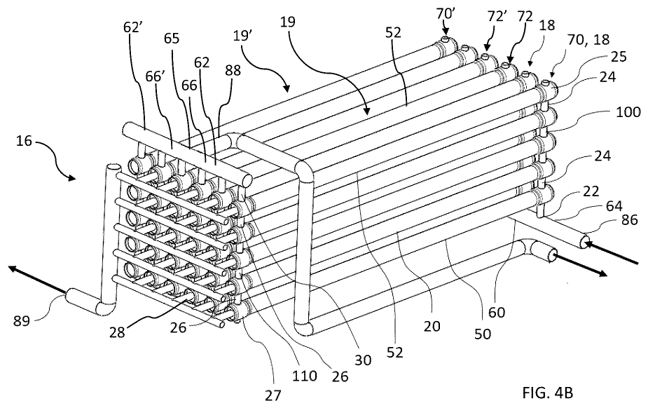

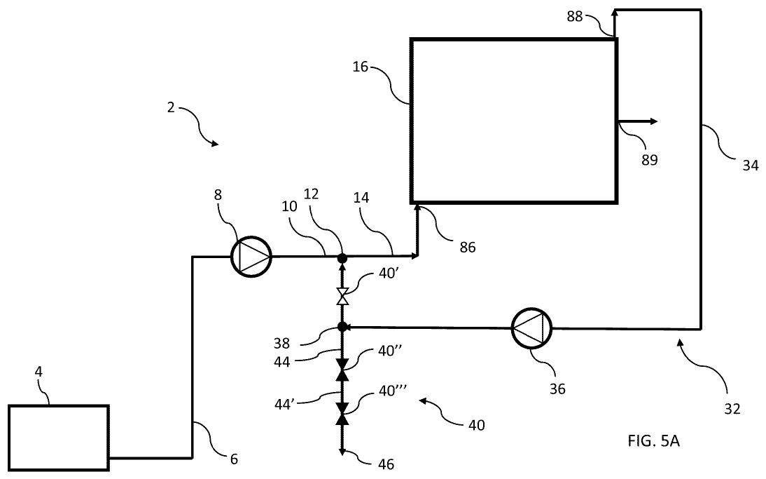

The filtration system preferably comprises a plurality of pressure vessel stack assemblies 18, including a first pressure vessel stack assembly 70 and a last pressure vessel stack assembly 72, as depicted in FIGS. 4a and 4b. Whereas FIGS. 2 and 3 depict individual pressure vessel stack assemblies 18, FIG. 4a illustrates an assembly of multiple pressure vessel stack assemblies 18 installed in parallel to form a pressure vessel array 16. Each pressure vessel stack assembly 18, including the first pressure vessel stack assembly 70 and the last pressure vessel stack assembly 72, are connected in parallel to each other. The stack inlets 22 of each pressure vessel stack assembly 18 are connected to an inlet header 60, and each inlet header 60 has an entrance 64 located nearest to the first pressure vessel stack assembly 70. The stack outlets 30 of each of pressure vessel stack assembly 18 are similarly connected to an outlet header 62, and each outlet header 62 has an outlet header exit 66 located nearest to the last pressure vessel stack assembly 72. Each of the individual pressure vessels 20 provides a distinct flow path 76 (see FIGS. 6a, 6b) within the recirculation loop 32 (see FIGS. 5a, 5b) that passes sequentially through the array inlet 86, the inlet header 60, a stack inlet 22, an individual pressure vessel 20, a stack outlet 30, the outlet header 62, and the array outlet 88. Parts of the pressure vessel array 16 between the array inlet 86 and array outlet 88 (e.g. the inlet header 60, a stack inlet 22, an individual pressure vessel 20, a stack outlet 30, and the outlet header 62) are illustrated in FIGS. 4a and 4b, but are not depicted in FIGS. 5a and 5b. The array inlet 86 is defined as the location directly upstream of a divergence of one distinct flow path 76 and the array outlet 88 is defined as the location directly downstream from the convergence of all distinct flow paths 76.

Still referring to FIGS. 4a and 4b, an inlet header 60 connected to the pressure vessel stack assembly 18 conveys feed solution into the stack inlet 22, which is located nearest the inlet port 24 of the first pressure vessel 50. Due to the configuration, solution entering the stack inlet 22 is in fluid connectivity with each of the parallel pressure vessels 20 through their inlet ports 24. The stack outlet 30, which is located nearest the outlet port 26 of the last pressure vessel 52, connects to an outlet header 62. For a pressure vessel array 16 that is configured into a roughly rectangular box-like geometry, as depicted in FIGS. 4a and 4b, the stack outlet 30 is located at the corner that is opposite that of the stack inlet 22, most preferably the corner that is diagonally opposite in the x, y, and z directions. Due to the configuration, solution exiting the stack outlet 30 is in fluid connectivity with each of the parallel pressure vessels 20 in the stack through the outlet ports 26. Additionally, the stack inlet 22 is in fluid communication with the stack outlet 30 through multiple distinct flow-paths through each pressure vessel 20, passing through the feed-concentrate channels of the hyperfiltration membrane elements 48 (not all hyperfiltration membrane elements are shown for clarity). While FIGS. 2 and 3 each show four pressure vessels 20 in each pressure vessel stack assembly 18, a preferred number of pressure vessels 20 in pressure vessel stack assemblies 18 that are part of a pressure vessel array 16 is greater than 2 and less than 10. Preferably, each pressure vessel 20 may contain between 3 and 8 elements 48 in series.

FIG. 4a illustrates one embodiment having multiple pressure vessel stack assemblies 18 in parallel to form a pressure vessel array 16. From the array inlet 86, solution is conveyed into an inlet header entrance 64 and into the inlet header 60. (The inlet header entrance 64 is upstream of all pressure vessel stack assemblies 18 and nearest the first pressure vessel stack assembly 70.) The solution is distributed from the inlet header 60 into the stack inlets 22 of multiple pressure vessel stack assemblies 18. From a stack inlet 22, solution passes through at least a part of an inlet conduit 100 before passing through one of the pressure vessels 20. On the downstream end 27 of the pressure vessel, solutions from different vessels 20 combine in an outlet conduit 110 and then enter the outlet header 62. Solution within the outlet header 62 leaves through the outlet header exit 66. (The outlet header exit 66 is downstream of each pressure vessel stack assembly 18 and nearest the last pressure vessel stack assembly 72.) Solution leaving pressure vessel array 16 and passing through the outlet header exit 66 is conveyed to an array outlet 88. Due to the configuration, solution entering the pressure vessel array 16 at the array inlet 86 is in fluid communication with the array outlet 88, with multiple flow paths between the array inlet 86 and array outlet 88 passing through the each of the pressure vessel stack assemblies 18 and through individual pressure vessels 20, passing through the feed-concentrate channels 84 of the hyperfiltration membrane elements 48 (shown in FIGS. 1 and 2). Based upon hydraulics of a system and flow path lengths, parallel pressure vessel stack assemblies 18 in each pressure vessel array 16 preferably number greater than 2 and preferably number less than 30. For pressure vessel arrays 16 larger than this, it is anticipated that many of the benefits will be diminished.

Referring now to FIG. 4b, an embodiment is depicted in which the recirculation loop 32 (shown in FIGS. 5a and 5b) comprises more than one pressure vessel stack assembly set 19 and each set is connected in parallel to a common array inlet 86 and to a common array outlet 88. Each pressure vessel stack assembly set 19 comprises an inlet header 60 connected to the array inlet 86 and an outlet header 62 connected to the array outlet 88. The pressure vessel stack assembly set comprises a first pressure vessel stack assembly 70, a last pressure vessel stack assembly 72, and at least one additional pressure vessel stack assembly 18 therebetween. In turn, each pressure vessel stack assembly 18 within the set 19 comprises a stack inlet 22 connected to the inlet header 60 on a first end 25 and a stack outlet 30 connected to the outlet header 62 on a second end 27. (As the “first end 25” and “second end 27” both describe the orientation relative to the pressure vessel axis, the descriptive terms apply equally to each of the pressure vessel 20 (as depicted in FIGS. 1, 2, and 3), the pressure vessel stack assembly 18, and the pressure vessel stack assembly set 19.) The header entrance 64 is located between the inlet header 60 and the array inlet 86, wherein the header entrance 64 is nearest the first pressure vessel stack assembly 70. The header exit 66 is located between the outlet header 62 and the array outlet 88, wherein the header exit 66 is nearest the last pressure vessel stack assembly 72.

The pressure vessel stack assembly set 19 provides several distinct flow paths 76 (as shown, for example, in FIGS. 6a and 6b). Referring to FIG. 4b, each pressure vessel 20 within the two pressure vessel stack assembly sets (19, 19′, etc.) is considered to provide one distinct flow path 76 within the recirculation loop 32 that passes sequentially through the array inlet 86, the pressure vessel stack assembly set 19, and array outlet 88.

Still referring to FIG. 4b, each pressure vessel assembly set 19 comprises an inlet header 60, an outlet header 62, a header entrance 64, and a header exit 66. First and second pressure vessel assembly sets (19, 19′) comprise several corresponding parts including first and second inlet headers (60, 60′), outlet headers (62, 62′), header entrances (64, 64′), header exits (66, 66′), first pressure vessel stack assemblies (70, 70′), and last pressure vessel stack assemblies (72, 72′). In FIG. 4b, several of these parts are illustrated and numbered for a first pressure vessel assembly set 19. FIG. 4b also shows labels for several key parts of a second pressure vessel assembly set 19′.

FIG. 4b further illustrates how outlet headers (62, 62′) from two different pressure vessel assembly sets (19, 19′) may be co-linear, adjacent, and directly connected. A common pipe forming the headers of two different pressure vessel assembly sets (19, 19′) would also be considered co-linear, adjacent, and directly connected. Similarly, for this purpose, a direct connection, such as the “T” connection 65 shown in FIG. 4b, that creates a split header and allows for removal of fluid from the combined headers, similarly results in two outlet headers (62, 62′) that are co-linear, adjacent, and directly connected. “T” connection 65, as depicted in FIG. 4b, is preferred embodiment; however, any suitable connection that produces a split header may be used. For example, the junction of pipes that forms the split header need not be rectilinear, and the diameters of the pipes joined at the split header need not be equal. FIG. 4b shows the first and second header exits (66, 66′) to be located between the first outlet header 60 and said second outlet header 62′. In some cases, the two header exits (66, 66′) are considered to coincide. In FIG. 4b, the perspective does not allow one to see the arrangement of the inlet headers (64, 64′). However, the structure may be analogous, and a split header may instead be created on the first end 25 by positioning header entrances (64, 64′) between inlet header (60, 60′). Preferably, however, only one of the entrance header combination and exit header combination is a split header.

FIG. 5a shows one embodiment of the filtration system described herein. This filtration system 2 includes a feed solution source 4 containing a solution to be treated. The source may be a pressurized source or a reservoir (e.g., a tank). Feed piping 6 conveys the feed solution from the feed solution source 4 to a high-pressure pump 8. The discharge from the high-pressure pump is conveyed by a pressurized feed path 10 to a first junction 12 where the feed solution may be mixed into a recirculation loop 32. The recirculation loop 32 includes the first junction 12, the entirety of the pressure vessel array 16, the recirculation line 34, a recirculation means 36, the second junction 38, and at least one valve 40′ of a valve collection 40.

Still referring to FIG. 5a, the mixed solution is conveyed by a mixed feed pipe 14 to an array inlet 86, and the mixed solution is distributed from there to a pressure vessel array 16, which comprises one or more pressure vessel stack assemblies 18 of pressure vessels 20 containing hyperfiltration membrane elements 48, as depicted in FIGS. 2, 3, 4a and 4b, for example. The partial separation occurs in the hyperfiltration membrane elements 48 (shown in FIGS. 1, 2, and 3), producing a low solute concentration permeate discharged from the permeate ports 28 of pressure vessels 20 and a high solute concentration retentate is discharged from pressure vessel outlet ports 26. As illustrated in FIGS. 4a and 4b, the combined permeate solution obtained from the permeate ports 28 is conveyed to the permeate outlet 89 of the pressure vessel array 16. The combined retentate solution obtained from the outlet ports 26 of pressure vessels 20 is conveyed to the array outlet 88 of the pressure vessel array 16.

FIG. 5a illustrates a configuration of valves suitable for the recirculation step or mode, wherein flow is enabled between the array outlet 88 and the array inlet 86, passing through the recirculation means 36 and the first junction 12 for example via a valve or valve means 40′. In this step, retentate from the array outlet 88 is mixed at the first junction 12 with feed solution from the high-pressure pump 8, and the mixture is conveyed by the mixed feed pipe 14 to the array inlet 86. In preferred embodiments, the filtration operates at least 50%, preferably at least 75%, or more preferably at least 90% of the time in this recirculation step. During this recirculation step, a permeate fluid having lower concentration than the feed is removed from the filtration system 2 via the permeate outlet 89 of the pressure vessel array 16 and this causes the concentration of fluid within the recirculation loop 32 to increase over time. The pressure of the high-pressure pump 8 is typically increased during this mode of operation to maintain a substantially constant permeate flow while in recirculation mode.

FIG. 5b illustrates a different configuration of valves suitable for the flushing step or mode, wherein flow is prevented between the array outlet 88 and the first junction 12 by a valve or valve means 40′, and flow of concentrate from the array outlet 88 is directed out of the recirculation loop 32. In the flushing step, fresh feed solution is provided to the recirculation loop 32 and the concentrated fluid from the array outlet 88 is removed from the filtration system 2 via retentate piping 44. Preferably, the system operates less than 50%, preferably less than 25%, and more preferably less than 10% of the time in the flushing step.

FIG. 5b further illustrates a different configuration of valves that creates an alternative flow path from the second junction 38, enabling the high solute concentration solution to be removed from the recirculation loop 32. Concentrated fluid is repeatedly and discontinuously released from the recirculation loop 32 by passing through a valve or valve means in the valve collection 40 via the retentate piping 44 and is discharged from the system at the retentate outlet 46.

Still referring to FIGS. 5a and 5b, the recirculation means 36 is required to sustain flow by adding pressure in the recirculation loop 32 prior to mixing that occurs at the first junction 12, to offset hydraulic pressure losses within the recirculation loop 32. This recirculation means 36 is most commonly a centrifugal pump, but can include other types of pumps, such as a positive displacement pumps using pistons, double pistons, rotors, screws, vanes, turbines or progressive cavities, as well as other means of inducing fluid flow, such as energy recovery devices, jets, eductors, declining volume tanks, pistons or cylinders. If a motor is coupled to the recirculation means, the motor can be equipped with a variable frequency drive to adjust the motor speed, and consequently pressure and flow.

The valve collection 40 may include a number of various configurations of valves and valve means, such as, for example, flow constriction devices and flow control devices that can direct, control or prevent fluid flow. When enabling flow in the recirculation loop, the valve collection 40 also prevents flow from the recirculation loop 32 to retentate outlet 46, through retentate piping 44. As illustrated in FIG. 5b, the valve collection 40 is also suitable to restrict flow within the recirculation loop 32 and to enable a discontinuous release of concentrated fluid from second junction 38 in the recirculation loop 32. Fluid is then able to pass from the second junction 38, through the retentate piping 44, and to a retentate outlet 46. At least one component in the valve collection 40 is within the recirculation loop 32. The valve collection 40 may include two separate two-way valves (40′, 40″), as illustrated in FIGS. 5a and 5b. Alternatively, the valve collection may comprise a three-way valve (not shown) at the second junction 38 that directs flow from the array outlet 88 to either the array inlet 86 or to the retentate outlet 46. Suitable valves and valve means useful for this purpose include, without limitation, a check-valve, a non-return valve, a conventional valve type (ball valve, butterfly valve, globe valve, plug valve, or orifice, or diaphragm valve, for example), Tesla valve, progressive cavity pumps, energy recovery devices and any other suitable mechanism that can moderate flow, prevent it, or direct it into the undesired flow path.

The valve collection 40 further comprises a system (not shown) for actuating the valves in the collection. Any system known in the art for this purpose is suitable for use in the systems described herein.

In a preferred embodiment, the valve collection 40 comprises two valves in series, each suitable to restrict flow between second junction 38 and the retentate outlet 46. One of these two valves 40′″ is preferably a manual throttle valve suitable for flow control and the other valves 40″ is suitable for rapid actuation by a control device.

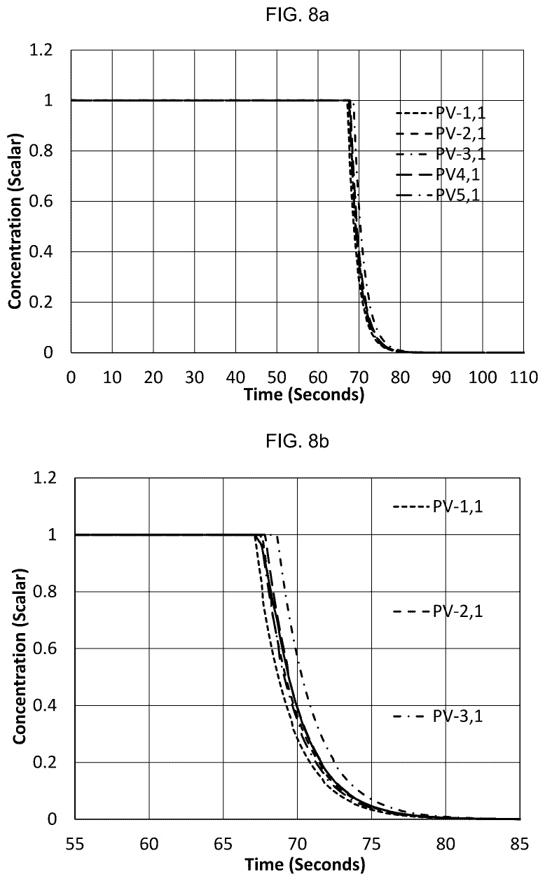

Further provided herein is a method for performing batch or semi-batch hyperfiltration (reverse osmosis or nanofiltration) using the system described herein. The method includes pressurizing a feed solution and flowing it into a pressure vessel array of hyperfiltration membrane elements. The hyperfiltration membrane elements separate the feed solution into a first stream (permeate) of lower concentration and second stream (concentrate or reject) of higher concentration. The valve collection is configurable to enable multiple repeated modes of operation in a batch or semi-batch process. The multiple modes of operation include at least:
1) a first mode of operation wherein the second (concentrate) stream is enabled to flow within a recirculation loop, mixing with the pressurized feed solution to form a new mixture that is re-conveyed preferably continuously to the pressure vessel array of hyperfiltration membrane elements. Due to removal of permeate from the recirculation loop during this mode, the solute concentration of the mixture in the recirculation loop increases as a function of time. Applied pressure of the mixture is also preferably increased over time to at least partially counter the impact of increased osmotic pressure. In some preferred embodiments, the volumetric flow of the first stream (permeate) leaving the recirculation loop is retained within 75%, or more preferably 90%, of its initial value during this mode; and
2) a second mode of operation wherein the second (concentrate) stream from the pressure vessel array of hyperfiltration elements is conveyed from the outlet of the pressure vessel array directly to a waste outlet. In this second mode, the configuration of the pressure vessel array results in a substantially uniform flushing profile of solute concentration in the second stream with respect to time. As used herein, the term “substantially uniform” refers to concentration vs. time curves in which the range of times when the solute concentrations in all the individual flow paths 74 in the pressure vessel array 16 or in the pressure vessel stack assembly 18 reach 50% of their initial value is less than 10%, less than 7%, less than 5%, less than 3%, less than 2.5%, or less than 2% of the average of these times for the individual flow paths 74. Referring to FIG. 8b, for example, when the scalar concentration is 0.5 (50% of the initial value of 1.0), the average time for the Array Combined (solid line) is about 69.5 seconds. The fastest time to reach this concentration is 68.7 seconds (dashed and dotted line), and the slowest time is about 70.5 seconds (dashed line). The range of times is 70.5−68.7=1.8 seconds, which is 2.59% of the average time of 69.5 seconds.

The filtration system 2 may be repeatedly switched between the first mode or recirculation mode and the second mode or flush mode of operation. The term “repeatedly,” as used herein, refers to an action that takes place more than once in a defined period of time, such as a day, and preferably more than once in a period of 2 hours. The time for switching may be determined using various set-points and measured variables, such as a target conductivity within the loop, target concentration of a solute, a target viscosity of the retentate, or target value for another analytical device. Properties of fluid within the recirculation loop, before or after mixing at the first junction 12, may be monitored to determine when to switch modes. Alternatively, set-points related to applied pressure or permeate flow could also be used.

Preferably, the conductivity within the recirculation loop decreases during the second mode of operation. More preferably, the time for the measured conductivity within the recirculation loop to decrease from 80% to 20% of the full conductivity range is less than 15 seconds, less than 12 seconds, less than 10 seconds, less than 7 seconds, less than 6 seconds, or less than 5 seconds.

As described briefly above, each pressure vessel 20 within a pressure vessel array 16 provides a distinct flow path 76 within said recirculation loop 32 that passes sequentially through the array inlet 86, the stack inlet 22, the hyperfiltration membrane elements 48 within that pressure vessel 20, the stack outlet 30, and the array outlet 88. FIGS. 6a and 6b show two different configurations of pressure vessel stack assemblies 18 and portions of distinct flow paths (74, 74′, 74″, 76, 76′, 76″) between the respective stack inlets 22 and stack outlets 30. (Not shown in views depicted in FIGS. 6a and 6b, array inlet 86 feeds the inlet header 60 and outlet header 62 feeds array outlet 88.) FIG. 6a depicts a pressure vessel stack assembly of the prior art, in which the stack inlet 22 and stack outlet 30 are located on adjacent corners of the stack assembly 18. In the configuration of FIG. 6b, the stack inlet 22 and stack outlet 30 are located on opposing corners of the pressure vessel array 16. Each of FIGS. 6a and 6b illustrates three distinct flow paths created by three vessels. It is clear from these figures and from the description of a path above, that the distinct flow paths 76 are defined by the corresponding vessel 20, but that other parts of two distinct flow paths 76 may overlap.

Illustrative of the conventional approach, FIG. 6a shows distinct flow paths 76, 76′, and 76″ through a pressure vessel array 16 comprised of a single prior art pressure vessel stack assembly 18. The stack inlet 22 and the stack outlet 30 are fluidly connected to the same pressure vessels 20. In this case, the length of the distinct flow path 76 through the last pressure vessel 52 is significantly longer than the distinct flow path 76″ through the first pressure vessel 50. When the flow-rates and volumes associated with each distinct flow path are calculated, the residence times for these two flow paths are significantly different, with a higher flow rate through distinct flow path 76″ than distinct flow path 76 and longer residence times in the distinct flow path 76 due to the different volumes associated with each flow path.

Significantly, more piping is required to create the pressure vessel array depicted in FIG. 6b, for example in the inlet headers and exit pipes. Nevertheless, this configuration is economically and environmentally more efficient, as it offers many advantages that are described in detail below. Specifically, by providing each distinct flow path with a substantially equal volume, the system described herein minimizes the volume of solution that is needed to purge the system in the flush cycle.

The advantages of having distinct flow paths (between array inlet 86 and array outlet 88) with substantially equal length and volume was illustrated by comparing stack assemblies 18 in FIGS. 6a and 6b. However, a two-dimensional pressure vessel array 16, such as those depicted in FIGS. 4a and 4b comprising a plurality of pressure vessel stack assemblies 18, provide a similar but greater opportunity to have favorable effect on fluid mixing subsequent to a discontinuous release of retentate concentrated fluid from the recirculation loop 32. The difference in residence times for distinct flow paths is reduced when the array inlet 86 and array outlet 88 connect to opposing corners of a multi-dimensional pressure vessel array. Similar to the effect illustrated in FIG. 6a, the difference in residence times increases when the array outlet 88 connects nearest the first pressure vessel stack assembly 70, which is the typical design utilized in hyperfiltration systems. By contrast, FIG. 4a shows the array outlet 88 connects to an outlet header 62 that has an exit 66 located nearest to the last pressure vessel stack assembly 72. At the same time, the array inlet 86 connects to an inlet header 60 that has an entrance 64 located nearest to the first pressure vessel stack assembly 70. In the configuration of FIG. 4a, the array inlet 86 and array outlet 88 connect to opposing corners of the pressure vessel array 16, such that the advantage illustrated with FIG. 4b are obtained in both directions of the two-dimensional array of vessels.

One method of quantifying the differences in flow distances is to utilize hydraulic residence times and hydraulic volumes of each distinct flow path. The hydraulic volume is defined as the flow weighted volume of each section of the system between the array inlet 86 and the array outlet 88 for each distinct flow path. (In FIGS. 6a and 6b, the illustrated portions of the distinct flow paths 76 and 74, respectively, connect the stack inlet 24 and the stack outlet 30.) For sections of the system where there is only one distinct flow path flowing through the section (for example the sub-section of each pressure vessel 20 containing hyperfiltration elements 48 has only one distinct flow path flowing through it) the hydraulic volume for that section for that distinct flow path is equal to the feed-concentrate volume of the hyperfiltration element 48. But for sections of the systems where multiple distinct flow paths are present, the contribution of the system volume for a section of the system to the hydraulic volume of each flow path is equal to:

$${V}_{H ( i , j )} = {V}_{j} \frac{{Q}_{i}}{{\sum }_{0}^{i} {Q}_{i}}$$

$$where$$

$${V}_{H ( i j )} = hydraulic volume of a section , j for a flow - path i$$

$${V}_{j} = volume of the section j$$

$${Q}_{i} = the flow of the distinct flow path through the section$$

$$i = the number of distinct flow paths flowing through the section .$$

The total hydraulic volume of a distinct flow path is equal to the sum of the hydraulic volumes for each section j of the system. By calculating the flow through an array using computational fluid dynamics, a nodal approach or other means, and using a mass balance to determine the flow of each distinct flow path in each system section, a theoretical hydraulic residence time can be calculated for each distinct flow path.

The theoretical hydraulic residence time assumes perfect plug flow throughout the system, without mixing, diffusion, axial dispersion, or other effects. In terms of the hydraulic residence time for each flow path, it is beneficial for the flows in each vessel to be similar to each other, preferably substantially equal to each other, preferably with a different between the highest flow and lowest flow of less than 20%, more preferably less than 10%, still more preferably less than 5% or less than 2%.

While FIG. 6a shows wide variations in the flow path lengths 76, 76′, and 76″, hydraulic volume and hydraulic residence times of each distinct flow path, the inventive array design (only a single stack assembly is illustrated) shown in FIG. 6b shows the improvement, that is, the minimized difference in flow path lengths 74, 74′, and 74″ associated with the system described herein. By configuring the stack such that the stack inlet 22 is closest to the first pressure vessel 50 and the stack outlet 30 is nearest to the last pressure vessel 52 in the stack, each distinct flow path (74, 74′, and 74″) has a similar path length, together with a similar, substantially equal associated hydraulic volume and a similar, substantially equal hydraulic residence time. Preferably, the variation in path length, hydraulic volume and hydraulic residence time is less than 20%, more preferably less than 10%, still more preferably less than 5% or less than 2%, as compared to the average path length, hydraulic volume, and hydraulic residence time, respectively, of all the individual flow paths 74 between array inlet 86 and array outlet 88.

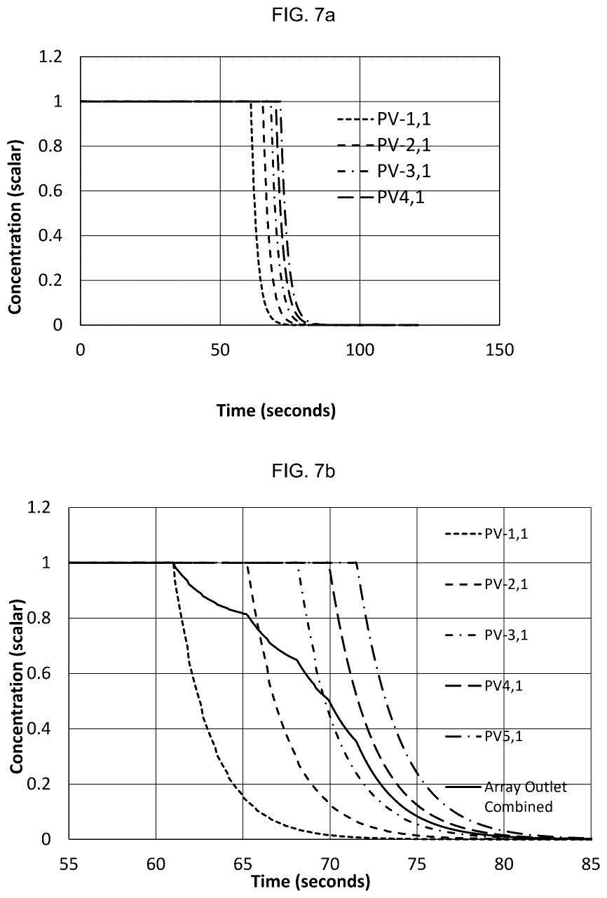

The benefit of the filtration system described herein for batch or semi-batch hyperfiltration becomes evident when considering the second mode of operation, as exemplified by FIGS. 7b and 8b. During the second mode of operation, it is preferable to flush all of the pressure vessels as uniformly as possible, so that all pressure vessels have the same mass of accumulated salts displaced from the system. With wide variations in the residence time of each distinct flow path, as shown in FIG. 7a, some pressure vessels in an array can be over-flushed while at the same point in time others remain under-flushed, and the system still contains a large mass of accumulated solute. This mass of accumulated solute is retained in the system for subsequent operation in the first mode of operation and can contribute to increased risk of scaling and fouling of the system.

The following example is provided to describe the invention in further detail. This example, which sets forth specific embodiments and a preferred mode presently contemplated for carrying out the invention, is intended to illustrate and not to limit the invention.

### Example. Semi-Batch Hyperfiltration Unit

### System Configuration

Array: One (1) stack assembly with
   five (5) vessels, suitable to contain six elements each,
   each having 3″ inlet ports; 2.5″ outlet ports,
   and containing 400 sq.ft. membrane elements
Mode: Second mode of operation (flushing)
Flow: 150 gpm
Solute Concentration in the system at t=0:1
Solute Concentration of the flush solution: 0
(for clarity, scalar values were used for concentration)

The system was modeled using computer hydraulic calculations and accounting for non-ideal mixing and axial dispersion in the pressure vessels, using both the prior art stack assembly and a preferred embodiment of the stack assembly described herein.

FIG. 7a shows a graph of scalar concentration versus time for each distinct flow path 74, produced by using the prior-art configuration such as the one shown in FIG. 6a, using five parallel pressure vessels 20 connected by the inlet ports 24 and outlet ports 26. The graph was developed from computer models that calculated the hydraulic volume and flow for each distinct flow path 74 and accounted for mixing and dispersion in the pressure vessels. The line labeled PV-1,1 corresponds with the first pressure vessel 50, and PV-5,1 corresponds to the last pressure vessel 52. At time equal to 0 seconds, the system enters into the second mode of operation. The region of most interest, between 60 and 85 seconds after initiating the second mode of operation, is shown in FIG. 7b. FIG. 7a shows that a time of 71 seconds is required to reduce the scalar concentration of solute in the distinct flow path corresponding to the first vessel to <0.01. The scalar concentration of the distinct flow path of the last pressure vessel is reduced to less than 0.01 about 83 seconds after initiating the second mode of operation.

The inefficiency of flushing during the second mode of operation is illustrated by the fact that the first pressure vessel 50 is fully flushed before the last pressure vessel 52 begins to break-through. During the time period from 71 seconds to 83 seconds, the first pressure vessel 50 is over-flushing. This trend continues for the other pressure vessels 20. The solute concentration curves can also be described by an actual hydraulic retention time (which is different from the theoretical hydraulic retention time defined previously). The actual hydraulic retention time (HRT_{actual}) accounts for the mixing and dispersion association with non-ideal flows. It is typically defined, in a negative step tracer study analysis, as the point at which the concentration scalar is reduced to 50% of the initial value. In this instance, the HRT_{actual} is 62.5 seconds for the distinct flow path 74 of the first pressure vessel 50 and 73.2 seconds for the last pressure vessel 52. For the five distinct flow paths modeled, the mean HRT_{actual} for the system was 68.8 seconds, with a standard deviation of 3.8.

In contrast, FIG. 8a shows a second graph of the hydraulic residence times resulting from the distinct flow paths in a preferred embodiment of the system described herein, such as the one shown in FIG. 6b, for example. FIG. 8b shows the region of greatest interest, between 60 seconds and 85 seconds. Unlike the prior art array, the preferred array has distinct flow paths 76 in the system, similar to those depicted in FIG. 6b, that are close to equal. All five vessels exhibit break-through of the conductivity scalar within 2 seconds of each other. In this instance, the HRT_{actual} is 68.7 seconds for the distinct flow path 74 of the first pressure vessel 50 and 70.3 seconds for the last pressure vessel 52. For the five distinct flow paths modeled, the mean HRT_{actual} for the system was 69.5 seconds, with a standard deviation of 0.82.

These data demonstrate that the flushing of the inventive system provides significantly less deviation between the various flow paths, and more solute is displaced from the system. Preferably, the distribution of actual hydraulic residence times of each distinct flow path has a standard deviation that is less than 5 seconds, more preferably less than 4 seconds, more preferably less than 3 seconds. When this methodology for the inventive system is applied with multiple pressure vessel stack assemblies 18, such as those shown in FIG. 4a and FIG. 4b, the benefits are even greater.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A filtration system 2 for treating a feed solution using batch or semi-batch hyperfiltration comprising:
a recirculation loop 32;
a feed solution source 4 of feed solution to be treated; a high-pressure pump 8 suitable to introduce the feed solution from the feed solution source 4 into the recirculation loop 32 at a first junction 12;
said recirculation loop 32 for treating said feed solution comprising:
a pressure vessel array 16 comprising a pressure vessel stack assembly 18, an array inlet 86 for feed, an array outlet 88 for retentate, and a permeate outlet 89;
said first junction 12;
a recirculation means 36 suitable to increase fluid pressure between the array outlet 88 and the array inlet 86; and
a second junction 38;
a valve collection 40 suitable to restrict flow within said recirculation loop 32 and to enable a discontinuous release of retentate from the recirculation loop 32 at said second junction 38 to a retentate outlet 46, wherein at least one component in said valve collection 40 is within said recirculation loop 32; and
a control device suitable to actuate said valve collection 40;
wherein said pressure vessel array 16 comprises a pressure vessel stack assembly 18 comprising:
at least three pressure vessels installed in parallel, said pressure vessels comprising a first pressure vessel 50, a last pressure vessel 52 and at least one pressure vessel 20 located between said first pressure vessel 50 and said last pressure vessel 52;
wherein each of said pressure vessel(s) 20 comprises one or more hyperfiltration membrane elements, one or more inlet ports 24 located nearest a first end of said pressure vessel(s) 20, one or more outlet ports 26 located nearest a second end of said pressure vessel(s) 20, a permeate port 28 located at one of said first end 25 or said second end 27 of said pressure vessel(s) 20, and one or more hyperfiltration membrane elements 48; and
wherein said inlet ports of the pressure vessel(s) 20 located adjacent to each other are connected at said first end 25 by an inlet conduit 100, and the outlet ports 26 of the pressure vessel(s) 20 located adjacent to each other are connected at said second end 27 by an outlet conduit 110;
said inlet conduit 100 fluidly connecting a stack inlet 22 to the inlet ports 24 of said at least three pressure vessels installed in parallel;
wherein said stack inlet 22 is located nearest the inlet port 24 of the first pressure vessel 50;
wherein said outlet conduit 110 fluidly connects a stack outlet 30 and the outlet ports 26 of said at least three pressure vessels installed in parallel; wherein said stack outlet 30 is located nearest the outlet port 26 of the last pressure vessel 52; and
wherein each of the at least three pressure vessels installed in parallel provides a distinct flow path 76 within the recirculation loop 32 that passes sequentially through the array inlet 86, the stack inlet 22, the hyperfiltration membrane elements 48 within one of said at least three pressure vessels installed in parallel, the stack outlet 30, and the array outlet 88.

2. The filtration system of claim 1, wherein the pressure vessel array 16 comprises a plurality of pressure vessel stack assemblies 18 including at least a first pressure vessel stack assembly 70 and a last pressure vessel stack assembly 72 wherein:
said first pressure vessel stack assembly 70 and said last pressure vessel stack assembly 72 are connected in parallel;
the stack inlet 22 of each of said first pressure vessel stack assembly 70 and said last pressure vessel stack assembly 72 are connected to an inlet header 60;
the stack outlets 30 of each of said first pressure vessel stack assembly 70 and said last pressure vessel stack assembly 72 are connected to an outlet header 62;
said inlet header 60 has an entrance 64 located nearest to said first pressure vessel stack assembly 70; and
said outlet header 62 has an exit 66 located nearest to said last pressure vessel stack assembly 72; and
and wherein each of said pressure vessel(s) 20 provides a distinct flow path 76 within said recirculation loop 32 that passes sequentially through the array inlet 86, the inlet header 60, the stack inlet 22, the pressure vessels 20, the stack outlet 30, the outlet header 62, and the array outlet 88.

3. The filtration system of claim 1, wherein:
each of the distinct flow paths 76 has a hydraulic volume; and
the hydraulic volume of each of the distinct flow paths 76 is substantially equal.

4. The filtration system of claim 1, wherein said valve collection 40 comprises two valves in series, each suitable to restrict flow between the second junction 38 and the retentate outlet 46.

5. The filtration system of claim 1, wherein one of said valves is a manual throttle valve suitable for flow control and one of said valves is suitable for rapid actuation by said control device.

6. The filtration system of claim 1, wherein said pressure vessel(s) 20 in each pressure vessel stack assembly 18 number greater than 2 and less than 8.

7. The filtration system of claim 1, wherein the parallel pressure vessel stack assemblies 18 in each array 16 number greater than 2 and less than 30.

8. A method for performing batch or semi-batch hyperfiltration using the filtration system of claim 1 wherein the method comprises:
pressurizing the feed solution and conveying said feed solution to the hyperfiltration membrane element(s);
said hyperfiltration membrane element(s) separating said feed solution into a first stream and a second stream, said first stream possessing a solute concentration lower than said feed solution and said second stream possessing a solute concentration greater than said feed solution;
wherein said filtration system is configurable to enable multiple modes of operation, said multiple modes comprising:
a first mode of operation wherein:
said second stream flow is enabled within said recirculation loop 32, such that said feed stream and said second stream combine to form a mixture and are re-conveyed to said hyperfiltration membrane element(s),
the concentration of solute in the recirculation loop 32 increases as a function of time, and
the pressure of said mixture is increased as a function of time; and
a second mode of operation wherein:
said second stream or said mixture is conveyed directly to a waste outlet, and
the configuration of the pressure vessel array 16 results in a substantially uniform flushing profile of solute concentration in the second stream with respect to time.

9. The method of claim 8, wherein:
each of the distinct flow paths 76 has a hydraulic residence time;
the hydraulic residence time of each of said distinct flow paths 76 has a variance from a mean of the hydraulic residence times of the distinct flow paths 76;
the variances in the hydraulic residence times of each distinct flow path 76 have a distribution and a standard deviation; and
said standard deviation is less than 5 seconds, more preferably less than 4 seconds, more preferably less than 3 seconds.

10. The method of claim 8, wherein conductivity is measured within the recirculation loop at different times; wherein the measured conductivity within the recirculation loop is caused to decrease during the second mode of operation; and wherein the time for the measured conductivity to decrease from 80% to 20% of the full conductivity range is less than 7 seconds.

11. The method of claim 8, wherein:
the pressure vessel array 16 has a first pressure drop between the inlet port 24 and the outlet port 26 of one pressure vessel 20;
said pressure vessel array 16 has a second pressure drop that is the maximum difference in the pressure between either both first ends 25 or both second ends 27 of two parallel pressure vessels 20; and
further wherein a ratio of said first pressure drop to said second pressure drop is greater than 5:1, more preferably greater than 10:1, more preferably greater than 15:1.

12. The filtration system of claim 1, wherein the array inlet 86 and array outlet 88 are each connected to a plurality of pressure vessel stack assembly sets 19 that are connected in parallel;
wherein each pressure vessel stack assembly set 19 comprises an inlet header 60 connected to the array inlet 86 and an outlet header 62 connected to the array outlet 88,
a first pressure vessel stack assembly 70, a last pressure vessel stack assembly 72, and at least one additional pressure vessel stack assembly 18 therebetween; wherein each pressure vessel stack assembly 18 within the set comprises a stack inlet 22 connected to the inlet header 60 on a first end 25 and a stack outlet 30 connected to the outlet header 62 on a second end 27,
a header entrance 64 located between the inlet header 60 and the array inlet 86, wherein the header entrance 64 is nearest the first pressure vessel stack assembly 70, and
a header exit 66 located between the outlet header 62 and the array inlet 86, wherein the header exit 66 is nearest the last pressure vessel stack assembly 72;
and wherein each pressure vessel 20 within the plurality of pressure vessel stack assembly sets 19 provides a distinct flow path 76 within the recirculation loop 32 that passes sequentially through the array inlet 86 and array outlet 88.

13. The filtration system of claim 1, wherein a first pressure vessel assembly set 19 comprises a first inlet header 60 and a first outlet header 62, and a second pressure vessel assembly set 19′ comprises a second inlet header 60′ and a second outlet header 62′; and wherein one or both pairs of (1) the first inlet header 60 and second inlet header 60′ and (2) the first outlet header 62 the second outlet header 62′ are co-linear, adjacent, and directly connected.

14. The filtration system of claim 1, comprising first and second pressure vessel assembly sets (19, 19′) and corresponding first and second inlet headers (60, 60′), first and second outlet headers (62, 62′), first and second a header entrances (64, 64′), and first and second header exits (66, 66′); and wherein exactly one of the following is true:
(1) said first and second header entrances (64, 64′) are located between said first inlet header 60 and said second inlet header 60′, or
(2) said first and second header exits (66, 66′) are located between said first outlet header 60 and said second outlet header 62′.
